(19) United States
(12) Patent Application Publication
(10) Pub. No.: US 2012/0022694 A1
(43) Pub. Date: Jan. 26, 2012

(54) CHEMICAL AND PHYSICAL DEGRADATION SENSING IN OIL

(75) Inventors: Pravansu S. Mohanty, Canton, MI (US); Ramesh K. Guduru, Canton, MI (US)

(73) Assignee: MRIDANGAM RESEARCH INTELLECTUAL PROPERTY TRUST, Canton, MI (US)

(21) Appl. No.: 13/187,616

(22) Filed: Jul. 21, 2011

Related U.S. Application Data
(60) Provisional application No. 61/366,646, filed on Jul. 22, 2010.

(51) Int. Cl. G01N 21/59; G08B 17/12; G05B 21/02; G06F 19/00

(52) U.S. Cl. 700/271; 250/301; 702/50; 340/600

(57) ABSTRACT

A sensing scheme comprising determining the chemical degradation and physical degradation in oil using variation in transmission behavior of oil for multi-wavelength electromagnetic radiation, and separating the contributory effect of physical degradation from the chemical degradation is disclosed. Further sensor designs employing the said scheme are disclosed.

### CROSS-REFERENCE TO RELATED APPLICATIONS

This application claims the benefit of U.S. Provisional Patent Application No. 61/366,646, filed on Jul. 22, 2010. The entire disclosures of the above application are incorporated herein by reference.

### FIELD OF THE INVENTION

This disclosure relates to the determination of physical and chemical degradation of oils, more particularly to sensor designs and sensing schemes for simultaneously detecting physical and chemical degradation in oil caused by heating, oxidation and suspended matter.

### BACKGROUND OF THE INVENTION

This section provides background information related to the present disclosure which is not necessarily prior art.

Different kinds of oils are used daily for different applications. For example, cooking oils are used in frying various types of food items, such as french fries, chicken, and fish, etc. Similarly, different grades of oils are used in many engineering applications for various purposes, such as lubrication and cooling, etc.

Irrespective of the applications as well as grades, all the oils undergo physical and chemical degradation during their usage. Chemical changes pertain to oxidation, hydrolysis and polymerization, etc., whereas physical degradation pertains to suspended foreign matters, such as metal debris, food particulates, water, corrosive materials (e.g.: KOH, soot), antifreeze, gasoline, glycol and dust, etc.

Physical as well as chemical degradation of oils can lead to inefficient performance of the oils during their services. For example, degraded cooking oils can result in less tasty and fatty food which may not be a healthy diet. On the other hand, the oils used in many engineering applications lose their lubrication and thermal capacity due to degradation in the quality.

Therefore, monitoring of oil quality on a regular basis is vital either for filtering or adding preservatives in order to enhance the performance. In addition, it is also necessary to monitor the degradation of oils in service in order to replace with the new oils.

There are different types of oil sensors available in the market. For example, they can sense the overall quality of the oils through the changes in dielectric properties or electrical properties or viscosity or color variations. However, they cannot distinguish the effect of physical degradation due to the contaminants or foreign materials from the chemical degradation.

Recently, the optical properties of oils have been exploited to determine the quality and thereby different sensing methods have been proposed [REFERENCES 1-4]; yet, they lack the differentiating capability between chemical and physical degradation simultaneously.

The change in transmission behavior of light through oils can happen either because of absorption or scattering phenomena, and thereby it is imperative to distinguish the effect of both the physical and chemical degradation on the absorption and scattering events in order to determine the quality of the oils.

A schematic transmission behavior of light in the range 200-800 nm wavelength through fresh and used oils is shown in FIG. 1. The transmission behavior in used oil shows both changes in cut off wavelength of the radiation that is being transmitted as well as reduced transmission within that cut off radiation zone compared to the fresh oil. These two changes are associated with the chemical as well as physical degradation of the oil. An effective sensing scheme should be able to distinguish the chemical and physical degradation components.

### SUMMARY OF THE INVENTION

This section provides a general summary of the disclosure, and is not a comprehensive disclosure of its full scope or all of its features.

A sensing scheme to distinguish the chemical degradation from the physical degradation and thereby corresponding sensor designs are disclosed.

The sensing scheme comprises the determination of absolute shift or change in the cut off wavelength of the radiation being transmitted due to the chemical degradation and subtraction of associated absolute change in transmission above the cut off wavelength using established correlations from the overall transmission above the cut off wavelength of the radiation, resulting in the transmission behavior that is associated with the physical degradation. Thus, it enables simultaneous detection of chemical and physical degradation in the oils.

The chemical degradation levels are determined by detecting the absolute change/shift in cut off wavelength of the transmitted radiation while transmitting different wavelengths of the light/radiation through the oil. It can be achieved using multi-color bulbs or multi color LEDs or multi wavelength light or radiation emitter in the UV-Visible-Infrared range coupled with a photoresistor and/or photodetector with a provision in between to store/flow the oil or to place a transparent (to the UV-Visible-Infrared light) container with oil inside so that the radiation could transmit through the oil before falling on the photoresistor or photodetector and then detect the extent of transmission of the radiation passed through the oil sample while varying the wavelength of the radiation and thereby observing the variation in the resistance value of the photoresistor and/or photodetector; then with the help of a microprocessor physical degradation can be detected by subtracting the absolute change/reduction in the transmission above the cut off wavelength of the radiation due to the chemical degradation from the observed transmission above the cut off wavelength of the radiation using prior established correlations between the absolute change/shift in the cut off wavelength of the radiation and the absolute change/reduction in transmission above the cut off wavelength of the radiation.

Further applicability will become apparent from the description provided herein. The description and specific examples in this summary are intended for purposes of illustration only and are not intended to limit the scope of the present disclosure.

### BRIEF DESCRIPTION OF THE DRAWINGS

The figures and drawings described herein are for illustrative purposes only of selected embodiments and not all possible implementations, and are not intended to limit the scope of the present disclosure.

FIG. 1 is an exemplary schematic comparison for an oil that has undergone both the physical and chemical degradation with respect to the fresh oil;

FIG. 2 is an exemplary schematic illustration for the effect of chemical degradation only on the transmission behavior of oils;

FIG. 3 is an exemplary schematic illustration for the correlation between the absolute change/shift in the wavelength of transmitted radiation through chemically degraded oil and the associated absolute change/reduction in the transmission of the radiation above the cut off wavelength of the radiation at different wavelengths;

FIG. 4 is an exemplary schematic for the effect of physical degradation on the transmission behavior of oils;

FIG. 5 is an exemplary schematic design for a dip-in oil sensor;

FIG. 6 is an exemplary schematic design for an inline oil sensor;

FIG. 7 is an exemplary illustration for variation in transmission behavior of fresh and chemically degraded oils as a function of the wavelength of the light being transmitted through different oxidized CANOLA OIL samples;

FIG. 8 is an exemplary illustration for variation in transmission behavior of fresh and chemically degraded oils as a function of the wavelength of the light being transmitted through different oxidized ENGINE OIL—30 samples;

FIG. 9 is an exemplary correlation between the absolute change in cut off wavelengths with respect to the fresh oil and the absolute change/reduction in the transmission values at the wavelength 800 nm for different oxidized CANOLA oil samples;

FIG. 10 is an exemplary illustration of variation in the transmission values for different concentrations of contaminants added in a FRESH CANOLA OIL sample as a function of the wavelength of the radiation being transmitted;

FIG. 11 is an exemplary illustration for variation in the transmission values for different concentrations of contaminants added in a CANOLA OIL sample heated for 12 hours as a function of the wavelength of the radiation being transmitted; and

FIG. 12 is an exemplary illustration for variation in the transmission values for different concentrations of contaminant KOH added in a FRESH ENGINE OIL 30 sample as a function of the wavelength of the radiation being transmitted.

Corresponding reference numerals indicate corresponding parts throughout the several views of the drawings.

### DETAILED DESCRIPTION OF THE PRESENT INVENTION

The present invention provides a process and a sensor for sensing oil degradation. As such, the present invention has use as a sensor.

The process includes irradiating a quantity of used oil with different wavelengths of electromagnetic radiation at a given intensity such that a first subset of wavelengths does not pass through the quantity of used oil and a second subset of wavelengths does pass through the quantity of used oil. In addition, a maximum wavelength of the first subset of wavelengths that does not transmit through the quantity of used oil and/or an amount of the electromagnetic radiation from the second set of wavelengths that is transmitted through the quantity of used oil is determined. Thereafter, a comparison is made between the maximum wavelength of the first subset of wavelengths and/or the amount of transmitted electromagnetic radiation from the second subset of wavelengths is made to a standard maximum wavelength and/or a standard amount of transmitted electromagnetic radiation, respectively.

A difference between the maximum wavelength of the first subset of wavelengths and the standard maximum wavelength can be a function of chemical degradation of the oil, the chemical degradation of the used oil can be a function of oxidation of the oil, hydrolysis of the oil, polymerization of the oil, heating of the oil, color change of the oil, disassociation of fats within the oil, disassociation of glycerides in the oil, formation of polar molecules in the oil, formation of alcohols in the oil, formation of aldehydes in the oil, and/or formation of ketones in the oil.

A difference between the amount of transmitted electromagnetic radiation from the second subset of wavelengths and the standard amount of transmitted electromagnetic radiation can be a function of physical degradation of the used oil, the physical degradation of the used oil being a function of solid particles, extraneous liquid and/or extraneous gas within the used oil.

In some instances, the different wavelengths of electromagnetic radiation range from wavelengths greater than 200 nanometers to wavelengths of at least 700 nanometers. In other instances, the different wavelengths of electromagnetic radiation range from wavelengths greater than 300 nanometers to wavelengths of at least 700 nanometers.

The process can further include determining when the used oil should be filtered and/or replaced as a function of the maximum wavelength of the first subset of wavelengths and/or the transmitted electromagnetic radiation from the second subset of wavelengths and their comparison to the standard maximum wavelength and the standard amount of transmitted electromagnetic radiation, respectively. In addition, the process can include determining when to add antioxidants to the used oil and/or the amount of free fatty acids remaining in the used oil.

The sensor can include a multi-wavelength electromagnetic radiation source that is operable to emit electromagnetic radiation having different wavelengths. In addition, the sensor can include a multi-wavelength electromagnetic radiation detector spaced apart from the radiation source with a transmission space between the source and the detector that is dimensioned for a quantity of oil to be located therebetween. A microprocessor can be in electronic communication with the multi-wavelength electromagnetic radiation detector and be operable to determine a minimum wavelength of electromagnetic radiation that has been emitted from the multi-wavelength electromagnetic radiation source and detected by the detector and/or a total amount of the electromagnetic radiation transmitted through the quantity of oil and detected by the detector. In addition, the microprocessor can compare the minimum wavelength to a standard wavelength and/or the total amount of electromagnetic radiation transmitted through the quantity of oil to a standard amount of electromagnetic radiation. In some instances, the standard wavelength and the standard amount of electromagnetic radiation can be established by transmitting different wavelengths of electromagnetic radiation through a quantity of unused oil.

In some instances, the multi-wavelength electromagnetic radiation source can emit radiation with wavelengths between 200 and 800 nanometers. In addition, the radiation source and the radiation detector can be sealed off from oil being tested.

The microprocessor can provide an alert signal that can alert an individual to change the oil that has been tested, filter the oil that has been tested, and/or add an antioxidant to the oil being tested. In addition, the sensor can be part of a handheld device and may or may not be dimensioned to be dipped into a quantity of oil to be tested. In the alternative, the sensor can be part of an inline device such that the sensor is located at least partially within a piece of tubing that has oil therein, the oil therein being tested by the sensor.

The sensor can include an alarm that is in electronic communication with the microprocessor, the alarm operable to provide an audible alarm and/or a visual alarm. Finally, the sensor can further include an automated oil replenishment system that is in electronic control with the microprocessor and is operable to filter the oil being tested, replace the oil being tested, and/or add an antioxidant to the oil being tested.

Non-limiting embodiments will now be described more fully with reference to the accompanying drawings.

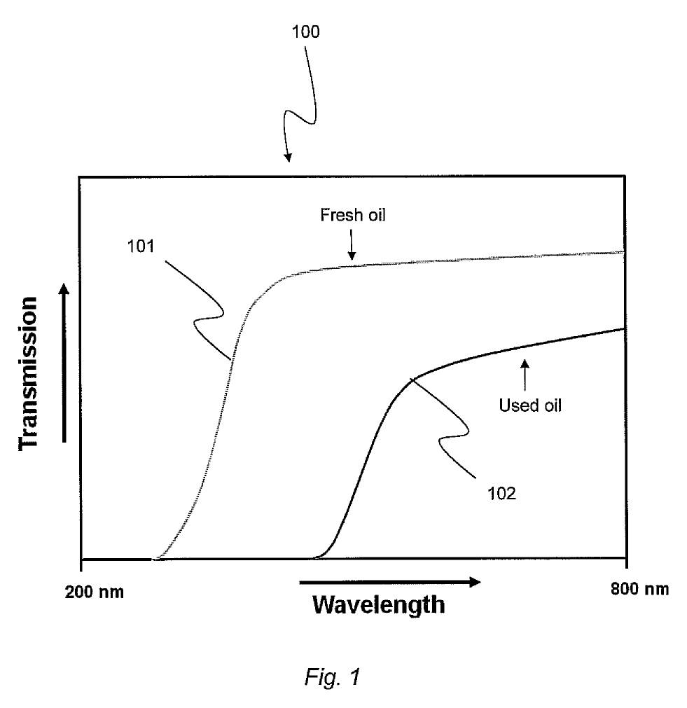

FIG. 1 is a schematic illustration for transmission behavior of electromagnetic radiation transmitting through the fresh oil 101 and used oil 102 that has undergone both the physical and chemical degradation because of oxidation, polymerization and contamination. The electromagnetic radiation transmission behavior through the degraded oil is influenced by both the physical and chemical degradation of the oil by affecting the absorption edge or cut off wavelength of the radiation and transmission of the radiation above the cut off wavelength of the radiation.

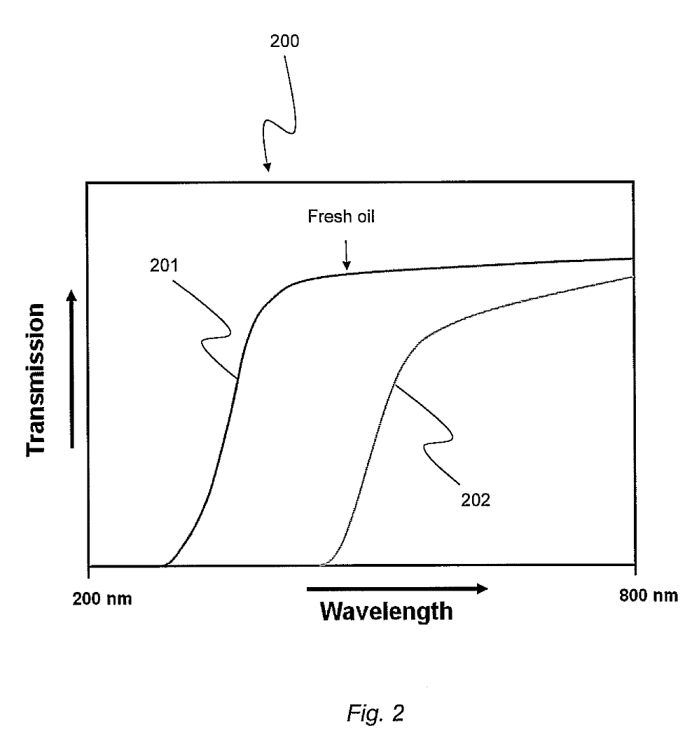

FIG. 2 is a schematic illustration for transmission behavior of electromagnetic radiation transmitting through the fresh oil 201 and chemically degraded oil 202; and the oil 202 is the resultant of continuous oxidation and heating of oil 201. Chemical degradation of the oil shifted the absorption edge or increased the wavelength of the radiation being transmitted as well as changed/reduced the extent of transmission of radiation above the cut off wavelength of the radiation with increasing the heating time or oxidation levels or the extent of chemical degradation.

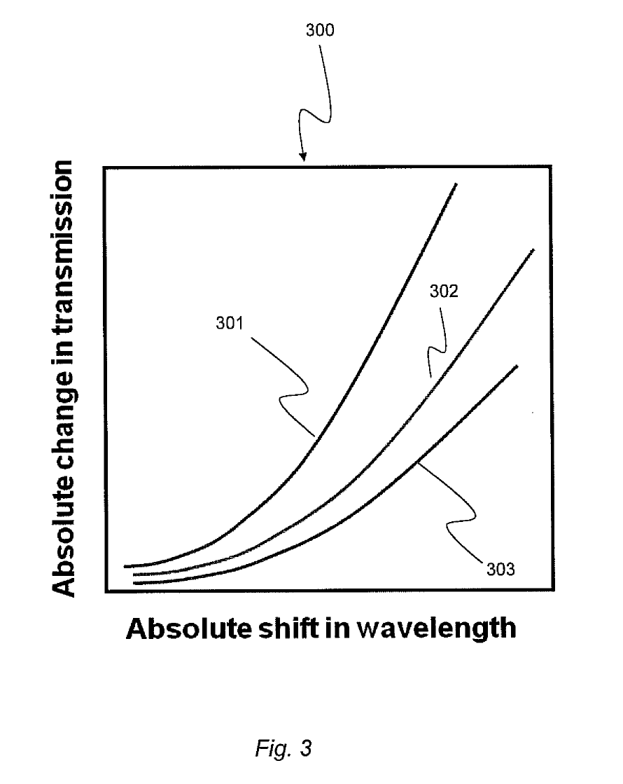

Further, as shown in FIG. 3, a chemically degraded oil has a correlation between the absolute change in the wavelength of the cut off radiation or the absorption edge and the absolute change in transmission of the radiation above the cut off wavelength of the radiation or absorption edge with respect to the fresh oil at three different wavelengths 301, 302 and 303 above the wavelength of the cut off radiation. With decreasing the wavelength in the order of 303, 302 and 301, there is more increase in the absolute change in the transmission values above the cut off radiation with absolute change/shift in the wavelength of the cut off radiation.

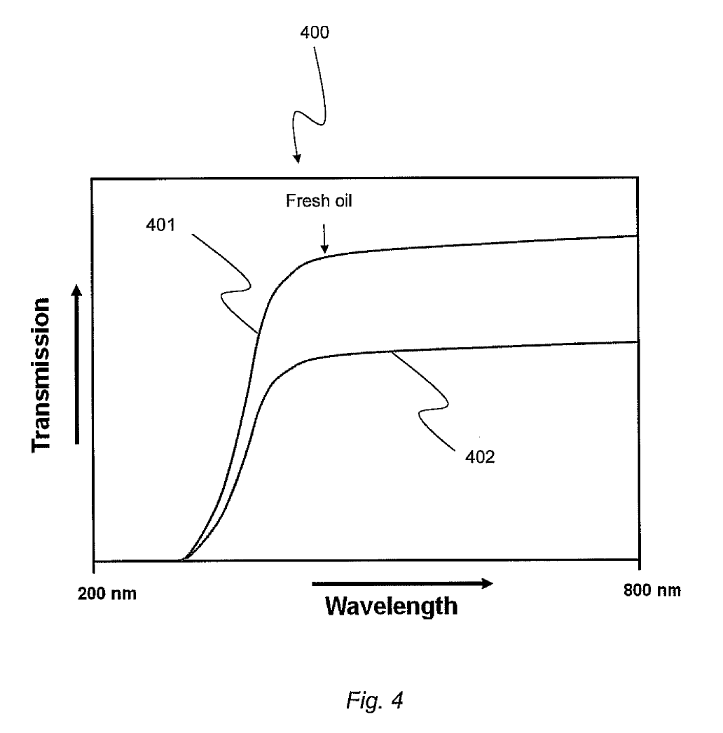

As shown in FIG. 4, the transmission behavior of electromagnetic radiation passing through the fresh oil 401, and physically degraded oil 402; the physical degradation of the oil caused a reduced transmission in the radiation being transmitted above the wavelength of the cut off radiation. The physical degradation of fresh oil 401 occurred because of contamination with the foreign material.

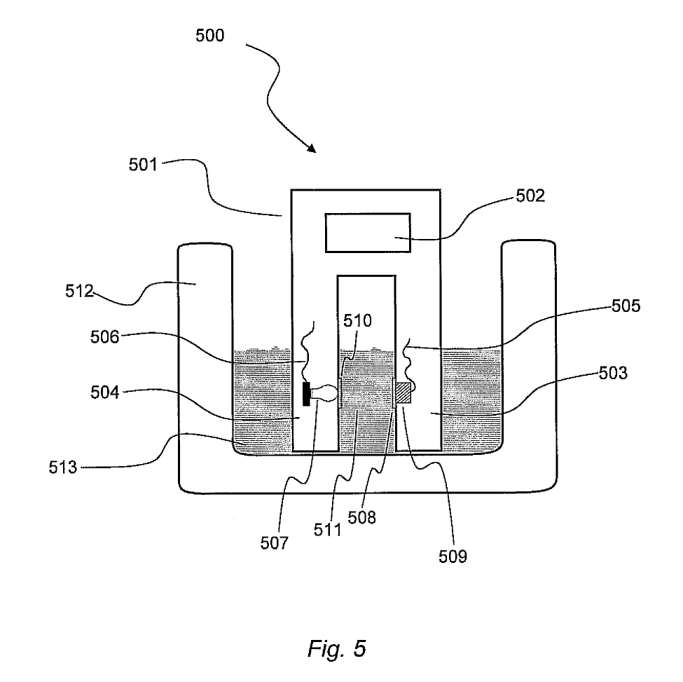

The distinctive transmission behavior of light as illustrated above can be employed in an exemplary sensor design as illustrated in FIG. 5. This dip-in OIL sensor 501 that could be used as a handheld device in households, restaurants, machineries, engines and industries. This device comprises of two legs 503 and 504 with a display 502 in the top. Both the legs can be partially dipped into the oil 513 till the multi color bulb/LEDs/light or multi radiation emitter in the UV-Visible-Infrared range 507 and the photoresistor/photodetector 509 are submerged in the oil. The multi color bulb/LEDs/light or multi radiation emitter 507 in the UV-Visible-Infrared range that is fixed inside the leg 504 will emit the radiation/light while varying the wavelengths. Thus emitted radiation or the light 511 will come out of the sensor 501 while transmitting through a transparent material or transparent glass 510 that is attached to the leg 504. This transparent material or transparent glass 510 will prevent the entry/leak of oil 513 or any other material into the sensor 501 or the leg 504. Then the radiation or the light 511 will traverse/transmit through the oil 513 that is between the two legs 504 and 503 and will enter into the transparent material or transparent glass cover 508 that is attached to the second leg 503. This radiation or the light 511 will then transmit through the transparent material or transparent glass 508 and fall on the photoresistor or the photodetector 509 which is in the leg 503. The transparent material or transparent glass 508 will prevent the entry/leak of oil 513 or any other material into the sensor 501 or the leg 503. The function of photoresistor or photodetector 509 is to measure the amount of light that is falling on it. The change in the resistance value of the photoresistor or photodetector 509 will give us a measure on the extent of the radiation or light or the intensity of the radiation or the light that is being transmitted through the oil, while varying the wavelength of the radiation or the light 511 by the multi color bulb/LEDs/light or multi radiation emitter 507 in the UV-Visible-Infrared range. The wire 506 that goes from the multi color light bulb/LEDs/light or multi radiation emitter 507 will be connected to a battery for power supply. The wire 505 that connects to the photoresistor or photodetector 509 will go to a microprocessor for the logic, data processing and analyzing.

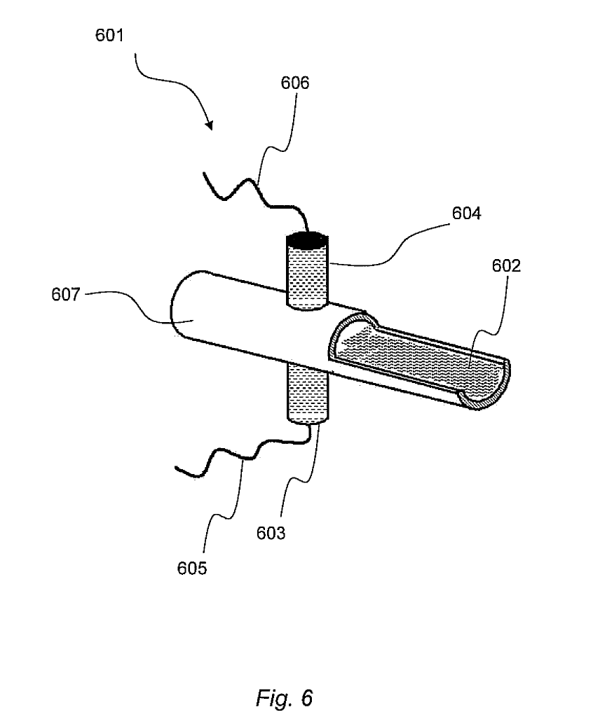

Similarly, the sensing scheme can be implemented in an inline sensor as shown in FIG. 6. This exemplary inline oil sensor 601 that could be used at the inlets and outlets of large scale oil chambers or deep fryers or oil filters. The oil sensor 601 works in the similar fashion as the dip-in oil sensor 501 does, in terms of working principle, sensor logic, sensing and calibration procedures. However, it can be fixed to storage containers, or pipes or tubes or passages or channels through which the oil flows into or out of the deep flyers, chambers or oil filters. The component 604 holds the photoresistor or photodetector 509 (shown in FIG. 5) with a transparent glass cover 508 (see FIG. 5) and the wire 506 attached to it goes to the microprocessor for the logic, data processing and analysis. The glass cover 508 will prevent the entry or leak of oil 602 or any other material into the component 604 and thus protect the photoresistor/photodetector 509. The component 603 houses the multi color light bulb/LEDs/light or multi radiation emitter 507 in the UV-Visible-Infrared range (shown in FIG. 5) with a transparent glass cover 510 (as shown in FIG. 5). The transparent glass cover 510 will also protect the multicolor bulb/LEDs/light or multi radiation emitter 507 in the UV-Visible-Infrared range and the component 603 from the oil 602 or any other leaks. The wire 605 attached to the component 603 goes to the power supply. The components 603 and 604 are attached to the pipe 607 on both sides with 180° apart and they are aligned in a straight line facing each other inside the pipe 607. The multi color bulb/LEDs/light or multi radiation emitter 507 in the UV-Visible-Infrared range will emit the radiation or light that can travel through the glass cover 510 and the media on the way and then fall on the glass cover 508 and then the photoresistor or photodetector 509. While the oil 602 flows through the pipe 607, the radiation or light emitted by the multi color bulb/LEDs/light or multi radiation emitter 507 in the UV-Visible-Infrared range will enter into the glass cover 510 and transmit through the flowing oil 602. Then the transmitted light through the oil 602 will enter into the glass cover 508, which will eventually fall on the photoresistor/photodetector 509.

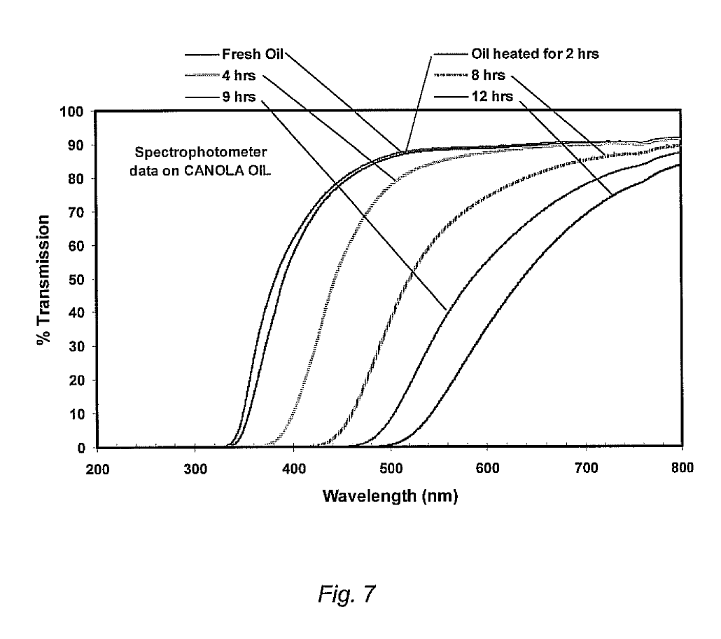

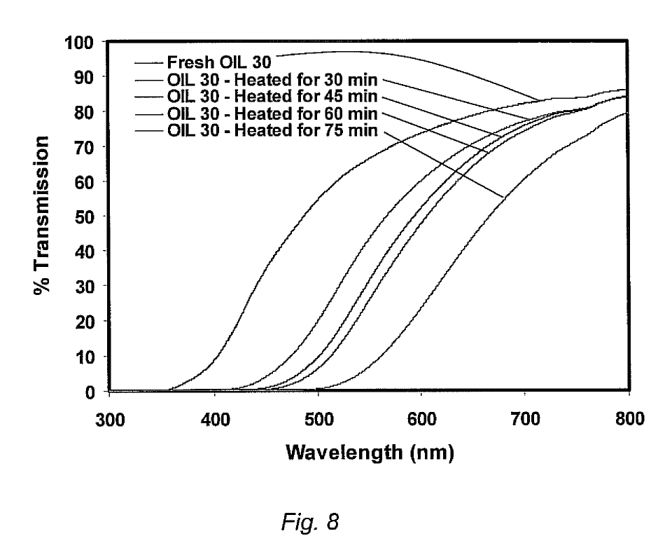

FIGS. 7 and 8 present sample transmission measurement of light in the UV-Visible-Infrared range in fresh OIL samples, and then continuously heated and oxidized OIL samples which have undergone chemical changes or chemical degradation through the oxidation and polymerization while heating them in the ambient atmospheric conditions for different time periods. It shows a systematic increase in the cut off wavelength of the light being transmitted with the extent of heating or chemical degradation of the oil samples. In addition, there is a corresponding decrease in the transmission at the wavelength 800 nm or anywhere above the cut off wavelength with increasing the heating period or chemical degradation of the oil.

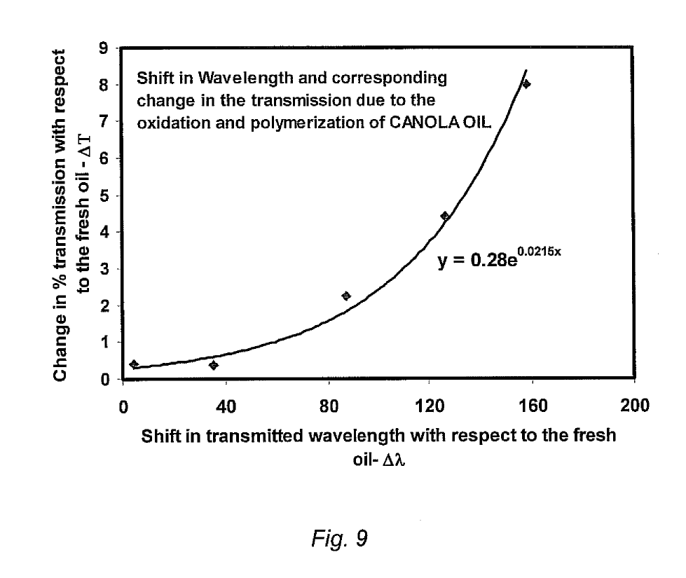

FIG. 9 presents a sample correlation between the extent of increase in the absolute wavelength (Δλ) of the cut off light and a change in transmission value ΔT at the 800 nm for CANOLA OIL samples heated for different time periods with respect to the fresh CANOLA OIL. The extent of increase in the cut off wavelength “Δλ” is calculated for any given oil sample with reference to the fresh oil. Therefore Δλ=λ_{cut off} for the given oil sample−λ_{cut off} for the fresh oil sample. In a similar fashion, the “ΔT” is also calculated with reference to the fresh oil as ΔT=T for fresh oil sample−T for given oil sample. Similar relations can be established for a change in transmission value ΔT at the wavelengths anywhere above the cut off wavelength.

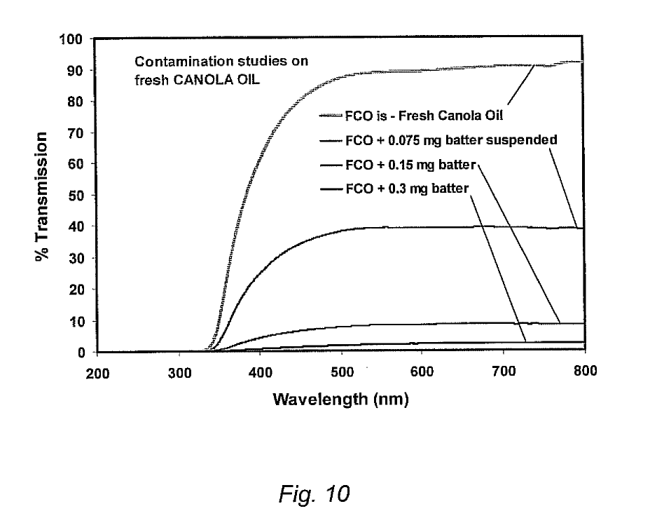

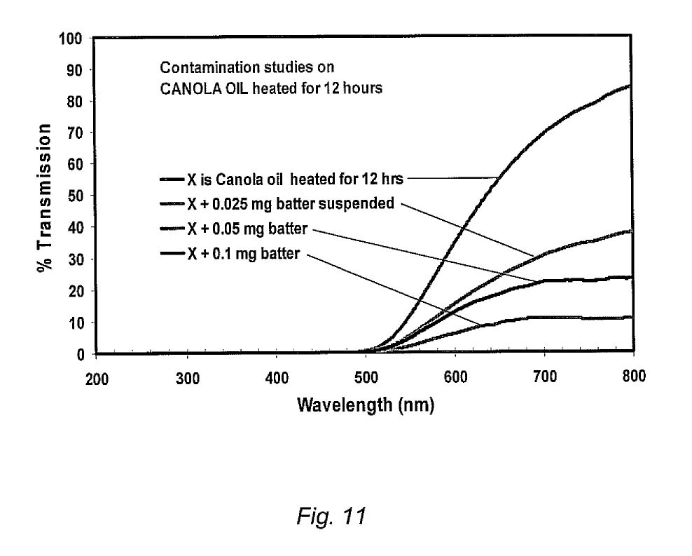

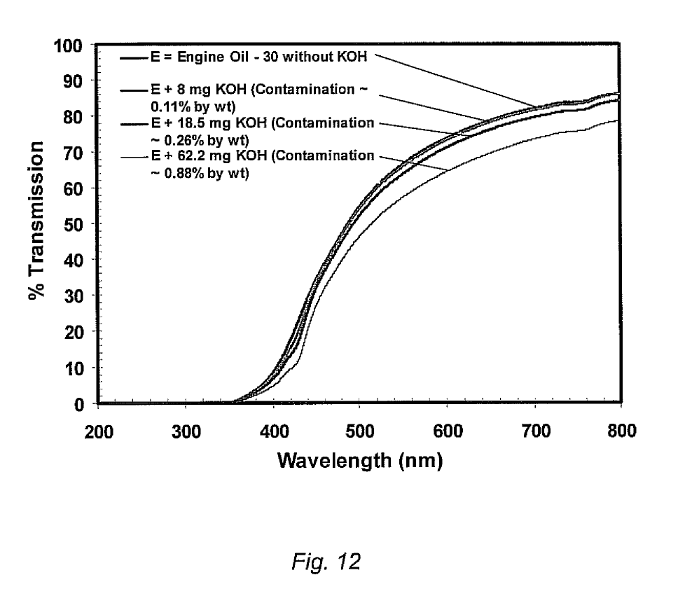

FIG. 10 is a sample illustration for the effect of physical degradation on the transmission properties of oils physically contaminated with different kinds of foreign materials, such as food particulates. FIG. 11 is an sample illustration for variation in the transmission values for different concentrations of contaminants added in a CANOLA OIL sample heated for 12 hours as a function of the wavelength of the radiation being transmitted. FIG. 12 is a sample illustration for variation in the transmission values for different concentrations of contaminant KOH added in a FRESH ENGINE OIL 30 sample as a function of the wavelength of the radiation being transmitted.

The described methods, techniques, approaches, analogies, apparatus, measurements, data, designs, geometries, illustrations, components and the sensors are example only. The details presented are understood by those skilled as examples only. Therefore, the methods, apparatus and designs and sensors for monitoring and determining the quality of oils qualitatively as well as quantitatively on a reference scale or user defined scale or on an absolute scale have been described with reference to preferred embodiments. Also, the unforeseen or unanticipated changes or alternatives, modifications, improvements and variations of the current teachings therein may be subsequently appreciated or made by those skilled in the art without departing from the scope of the invention are also intended to be encompassed by the following claims.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises”, “comprising”, “including”, and “having” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on”, “directly engaged to”, “directly connected to” or “directly coupled to” another element or layer, there may be no intervening elements or layers present. Other words used to describe the relationship between elements should be interpreted in a like fashion (e.g., “between” versus “directly between”, “adjacent” versus “directly adjacent”, etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first”, “second”, and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner”, “outer”, “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

REFERENCES CITED
U.S. PATENT DOCUMENTS
REFERENCE 1

| | | | |
|---|---|---|---|
| 7,321,117 B2 | June 2008 | James Z. T. Liu | 250/301 |

REFERENCE 2

| | | | |
|---|---|---|---|
| 216,464 A1 | August 2009 | Ho Sung Kong et al. | 702/25 |

REFERENCE 3

| | | | |
|---|---|---|---|
| 44,707 A1 | February 2009 | Jan Claesson et al. | 99/403 |

REFERENCE 4

| | | | |
|---|---|---|---|
| 6,717,667 B2 | April 2004 | Varghese Abraham | 356/318 |

1. A process for sensing oil degradation, the process comprising:
irradiating a quantity of used oil with different wavelengths of electromagnetic radiation at a given intensity such that a first subset of wavelengths does not pass through the quantity of used oil and a second subset of wavelengths does pass through the quantity of used oil;
determining at least one of a maximum wavelength of the first subset of wavelengths that does not transmit through the quantity of used oil and an amount of the electromagnetic radiation from the second subset of wavelengths that is transmitted through the quantity of used oil; and
comparing at least one of the maximum wavelength of the first subset of wavelengths and the amount of transmitted electromagnetic radiation from the second subset of wavelengths to a standard maximum wavelength and a standard amount of transmitted electromagnetic radiation, respectively.

2. The process of claim 1, wherein a difference between the maximum wavelength of the first subset of wavelengths and the standard maximum wavelength is a function of chemical degradation of the used oil.

3. The process of claim 2, wherein the chemical degradation of the used oil is due to the occurrence of at least one of oxidation of the oil, hydrolysis of the oil, polymerization of the oil, heating of the oil, a color change of the oil, dissociation of fats within the oil, dissociation of glycerides in the oil, formation of polar molecules in the oil, formation of alcohols in the oil, formation of aldehydes in the oil and formation of ketones in the oil.

4. The process of claim 1, wherein a difference between the amount of transmitted electromagnetic radiation from the second subset of wavelengths and the standard amount of transmitted electromagnetic radiation is a function of physical degradation of the used oil.

5. The process of claim 4, wherein the physical degradation of the used oil is due to the presence of at least one of solid particles, an extraneous liquid and an extraneous gas in the used oil.

6. The process of claim 1, wherein the different wavelengths of electromagnetic radiation range from wavelengths greater than 200 nanometers to wavelengths at least 700 nanometers.

7. The process of claim 6, wherein the different wavelengths of electromagnetic radiation range from wavelengths greater than 300 nanometers to wavelengths at least 700 nanometers.

8. The process of claim 1, further including determining when the used oil should be at least one of filtered and/or replaced as a function of the comparison of the at least one of the maximum wavelength of the first subset of wavelengths and the amount of transmitted electromagnetic radiation from the second subset of wavelengths to a standard maximum wavelength and a standard amount of transmitted electromagnetic radiation, respectively.

9. The process of claim 1, further including determining when to add antioxidants to the used oil as a function of the comparison of the at least one of the maximum wavelength of the first subset of wavelengths and the amount of transmitted electromagnetic radiation from the second subset of wavelengths to a standard maximum wavelength and a standard amount of transmitted electromagnetic radiation, respectively.

10. The process of claim 1, further including automatically at least one of changing the used oil, filtering the used oil and adding antioxidants to the used oil as a function of the comparison of the at least one of the maximum wavelength of the first subset of wavelengths and the amount of transmitted electromagnetic radiation from the second subset of wavelengths to a standard maximum wavelength and a standard amount of transmitted electromagnetic radiation, respectively.

11. The process of claim 1, further including determining the amount of free fatty acids remaining in the used oil as a function of the comparison of the at least one of the maximum wavelength of the first subset of wavelengths and the amount of transmitted electromagnetic radiation from the second subset of wavelengths to a standard maximum wavelength and a standard amount of transmitted electromagnetic radiation, respectively.

12. A sensor for determining oil degradation, said sensor comprising:
a multi-wavelength electromagnetic radiation source operable to emit multi-wavelength electromagnetic radiation;
a multi-wavelength electromagnetic radiation detector spaced apart from said multi-wavelength electromagnetic radiation source;
a transmission space between said multi-wavelength electromagnetic radiation source and said multi-wavelength electromagnetic radiation detector, said transmission space dimensioned for a quantity of oil to be located therebetween; and
a microprocessor in electronic communication with said multi-wavelength electromagnetic radiation detector and operable to determine at least one of a minimum wavelength of electromagnetic radiation that has been emitted from said multi-wavelength electromagnetic radiation source and detected by said multi-wavelength electromagnetic radiation detector, a total amount of electromagnetic radiation transmitted through the quantity of oil and detected by said multi-wavelength electromagnetic radiation detector, a comparison of said minimum wavelength of electromagnetic radiation to a standard wavelength of electromagnetic radiation and a comparison of said total amount of electromagnetic radiation transmitted through the quantity of oil to a standard amount of electromagnetic radiation.

13. The sensor of claim 12, wherein said multi-wavelength electromagnetic radiation source emits radiation with wavelengths between 200 nanometers and 800 nanometers.

14. The sensor of claim 12, wherein at least one of said multi-wavelength electromagnetic radiation source and said multi-wavelength electromagnetic radiation detector are sealed off from oil being tested.

15. The sensor of claim 12, wherein said microprocessor provides an alert signal to perform at least one of change an oil being tested, filter an oil being tested and add an antioxidant and/or preservatives to an oil being tested.

16. The sensor of claim 12, wherein said multi-wavelength electromagnetic radiation source, said multi-wavelength electromagnetic radiation detector and said microprocessor are part of a handheld device.

17. The sensor of claim 16, wherein said handheld device can be dipped into a quantity of oil to be tested.

18. The sensor of claim 12, wherein said multi-wavelength electromagnetic radiation source, said multi-wavelength electromagnetic radiation detector and said microprocessor are part of an inline device.

19. The sensor of claim 12, further comprising an alarm in electronic communication with said microprocessor, said alarm operable to provide at least one of an audible alarm signal and a visual alarm signal.

20. The sensor of claim 12, further comprising an automated oil replenishment system in electronic control with said microprocessor and operable to perform at least one of change an oil being tested, filter an oil being tested and add an antioxidant to an oil being tested as a function of at least one of said comparison of said minimum wavelength of electromagnetic radiation to a standard wavelength of electromagnetic radiation and said comparison of said total amount of electromagnetic radiation transmitted through the quantity of oil to a standard amount of electromagnetic radiation.
